(19) United States
(12) Patent Application Publication
(10) Pub. No.: US 2008/0251412 A1
(43) Pub. Date: Oct. 16, 2008

(54) FOOD SERVICE TRAY WITH INTEGRATED BEVERAGE CONTAINER HOLDER

(76) Inventors: Darrell Oresky, Fairfax Station, VA (US); Colleen Marie Oresky, Fairfax Station, VA (US); Christine Marie Oresky, Fairfax Station, VA (US); Michelle Rose Oresky, Fairfax Station, VA (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 12/100,796

(22) Filed: Apr. 10, 2008

Related U.S. Application Data
(60) Provisional application No. 60/923,008, filed on Apr. 12, 2007.

(51) Int. Cl. B65D 1/34; B23P 17/00

(52) U.S. Cl. 206/557; 29/592

(57) ABSTRACT

A circular hole large enough to support a variety of beverage containers is formed in a food tray and surrounded by a lip about the height of the lip around the edge of the tray. A flexible mesh is integrated into the hole. The material of the mesh stretches below the food service tray when a beverage container is placed in the hole, and return to a position level with the surface with the food service tray when the beverage container is removed. A semi-mesh embodiment includes a disc of rigid material at the center of the mesh.

### RELATED APPLICATIONS

This application claims the benefit of U.S. Provisional Application No. 60/923,008, filed Apr. 12, 2007, which is hereby incorporated by reference.

### BACKGROUND

This invention relates generally to the food service industry, where reusable trays are used to transport food from the ordering or food preparation station to seating locations. More particularly, this invention relates to a method and apparatus for preventing a beverage container from tipping over or falling off the tray while being carried on the tray.

Food service trays are used in restaurant and cafeteria situations to provide a way to transport food from the ordering or food preparation stations to seating locations.

Typical food service trays are rectangular in shape and made of plastic. The surface of the tray is flat except for, typically, a small lip around the edge of the tray that prevents items from falling off the tray when the tray is slightly tilted, as may naturally occur when the tray is being carried.

While the lip found on a typical tray is sufficient to prevent most food items from falling off the tray under general carrying situations, the height of the lip is generally insufficient to prevent a filled beverage container from falling off or being tipped over by the lip, due to the high center of gravity of the filled beverage container relative to the surface of the tray.

Existing tray designs with integrated beverage container holders result in a tray that in profile is taller than the lip of the tray. This increases the space required for stacking and storage, increases the difficulty of cleaning the trays, and presents problems adjusting to various sized beverage containers.

There is currently no solution that provides a tray with an integrated cup holder that results in the tray being no higher than the lip of the tray, is easy to clean, and is adjustable for various sized beverage containers.

What would be really useful would be a tray design that modifies existing trays in such a way that an integrated beverage container holder results in the tray still being no taller than the lip of the tray, does not increase the difficulty in cleaning the tray, and can support a variety of different sizes of beverage containers without modification or adjustment. Such a system would have benefits to both the food service industry and to tray users.

### SUMMARY

Disclosed embodiments provide a food service tray that contains an integrated beverage container holder while maintaining the tray as a flat, easy to clean surface.

Disclosed embodiments integrate a beverage container holder into the general existing design of food service trays.

Disclosed embodiments provide a food service tray with an integrated beverage container holder that is no taller than the lip of the tray when stored.

Disclosed embodiments do not require any changes to existing food service tray cleaning methods or mechanisms.

Disclosed embodiments support, without any adjustment, a variety of different sized beverage containers.

Disclosed embodiments greatly reduce the likelihood of a beverage container being spilled or falling off of the tray during transport.

According to one embodiment, a method includes 1) placing a circular hole, large enough to support a variety of beverage containers, in the tray, surrounded by a lip no taller than the lip around the edge of the tray, and 2) the integration of a flexible mesh into the hole. The lip around the hole provides an indication of where to place the beverage container. The material of the mesh will stretch below the food service tray when a beverage container is placed in the hole, and return to a position level with the surface with the food service tray when the beverage container is removed. The mesh may be all mesh, or may contain a piece of tray material in the center, surrounded by a donut of mesh.

The size of the hole will be large enough, and the flexibility of the mesh variable enough, to allow for a variety of different size beverage containers, when full and placed in the hole, to rest slightly below the surface of the tray, supported by the mesh.

In the donut mesh design, the center piece of tray material should be large enough to support the bottom of the largest beverage container that could be placed in the hole.

In this state, the center of gravity of the full beverage container has been lowered relative to the surface of the tray, making it less likely the beverage container will tip over during transport. In addition, the surface of the tray now supports the side of the beverage container, instead of the beverage container resting on the surface of the tray, virtually eliminating the possibility of the beverage container moving around on the tray during transport.

### BRIEF DESCRIPTION OF DRAWINGS

FIG. 1 is a top view of a food tray with an integrated beverage container holder.

FIG. 2 is a cutaway side view of a food tray with an integrated beverage container holder, without a beverage container.

FIG. 3 is a cutaway side view of a food tray with an integrated beverage container holder, with a beverage container.

FIG. 4 is a top view of a food tray with a semi-mesh version of an integrated beverage container holder.

FIG. 5 is a cutaway side view of a food tray with a semi-mesh version of an integrated beverage container holder, without a beverage container.

FIG. 6 is a cutaway side view of a food tray with a semi-mesh integrated beverage holder container, with a beverage container.

### DETAILED DESCRIPTION

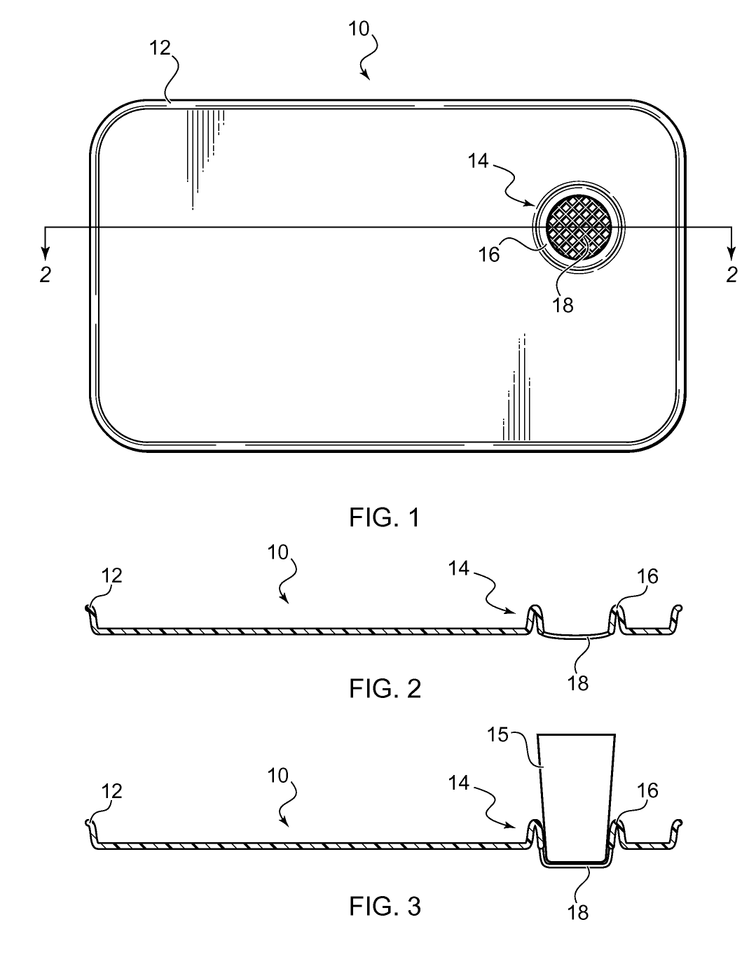

FIG. 1 shows implementation of this invention via an illustrated embodiment. A hole with a lip 16 around it (i.e. the beverage container holder 14) has been formed in a food tray 10 that has a peripheral lip 12. The figure show the beverage container holder 14 located in the upper right corner of the tray 10. The beverage container holder 14 may optionally be located anywhere on the tray 10. However, a location towards a corner of the tray 10 maximizes the space available for other items on the tray 10.

Inside the hole, a mesh 18 is mounted. The mesh 18 is made of a flexible, plastic and/or rubber material. The size of the hole is variable depending on the situation. The hole should be approximately 1″ larger in diameter than the bottom of the largest beverage container to be used with the tray 10.

FIG. 2 shows a cutaway side view of the illustrated embodiment. The lip 16 surrounding the hole should be no taller than the lip 12 typically found around the edge of the tray 10. Further, the lip 16 should itself be hollow, and shaped to allow multiple trays 10 to stack in a flat manner. The mesh 18, when not in use, returns to a position parallel with the surface of the tray 10.

FIG. 3 shows a cutaway side view of the illustrated embodiment, in use with a filled beverage container 15 in the beverage container holder 14, when the tray 10 is being held up in the air. Note that the mesh 18 has now stretched below the surface of the tray 10, under the weight of the filled beverage container 15. In this configuration, the center of gravity of the filled beverage container 15 is now lower, reducing the chance of the beverage container 15 being spilled while being transported. Further, the probability that the beverage container 15 might slide or fall off the tray 10 is virtually eliminated.

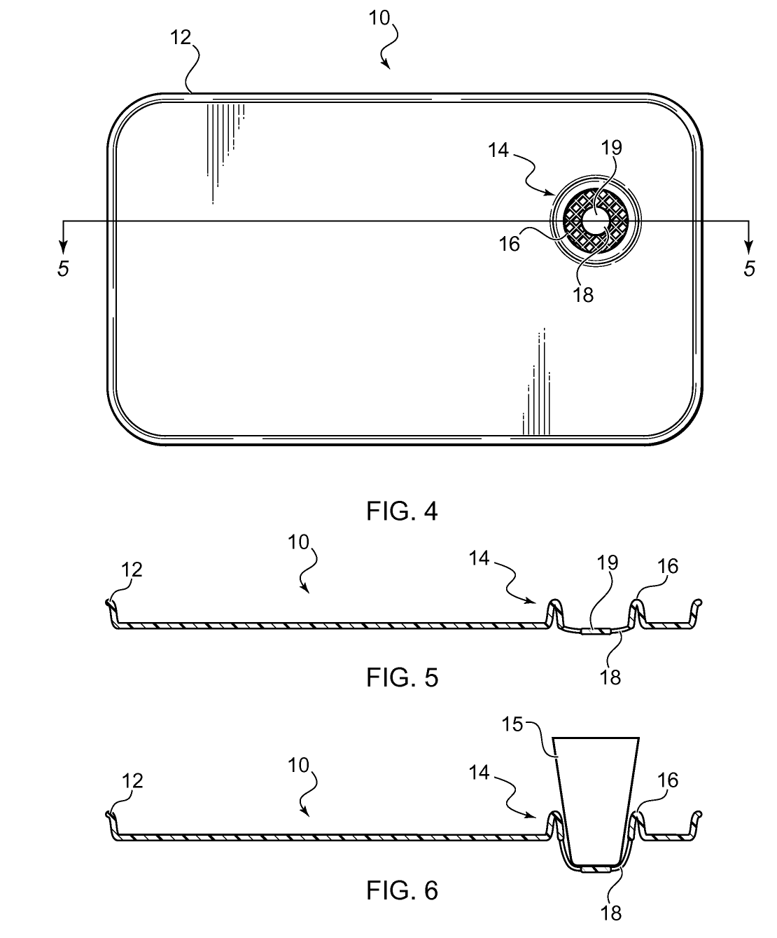

FIG. 4 shows another implementation of this invention incorporating a semi-mesh arrangement. As used herein, semi-mesh refers to a beverage container holder 14 with a central portion 19 of tray material that is surrounded by a “donut” portion of flexible mesh 18. A hole with a lip 16 around it (i.e. the beverage container holder 14) is formed in a food tray 10 that has a peripheral lip 12. The mesh 19 connects portion 19 to lip 16. Again, the figure shows the beverage container holder 14 located in the upper right corner of the tray 10. The beverage container holder 14 may optionally be located anywhere on the tray 10. However, a location towards a corner of the tray 10 maximizes the space available for other items on the tray 10.

The mesh 18 is made of a flexible, plastic and/or rubber material and the portion 19 is made of tray material and/or other rigid material that can withstand tray-washing. The size of the hole is variable depending on the situation. The hole should be approximately 1″ larger in diameter than the bottom of the largest beverage container to be used with the tray 10. The portion 19 should be at least approximately the size of the bottom of the smallest beverage container to be used with the tray 10.

FIG. 5 shows a cutaway side view of the semi-mesh embodiment. The lip 16 surrounding the hole should be no taller than the lip 12 typically found around the edge of the tray 10. Further, the lip 16 should itself be hollow, and shaped to allow multiple trays 10 to stack in a flat manner. The mesh 18 and portion 19, when not in use, return to a position parallel with the surface of the tray 10.

FIG. 6 shows a cutaway side view of the semi-mesh embodiment, in use with a filled beverage container 15 in the beverage container holder 14, when the tray 10 is being held up in the air. Note that the mesh 18 and portion 19 have now stretched below the surface of the tray 10, under the weight of the filled beverage container 15. In this configuration, the center of gravity of the filled beverage container 15 is now lower, reducing the chance of the beverage container 15 being spilled while being transported. Further, the probability that the beverage container 15 might slide or fall off the tray 10 is virtually eliminated.

The flexibility of the mesh material is important to advantageous operation and use of this feature. It should stretch at least 1″ to 2″ below the surface of the tray, when the smallest filled beverage container is placed in the holder. The mesh, however, should not be so flexible as to become weak when fully stretched or to loose flexibility over time. A suitable solution is for the mesh to have a maximum stretch distance that will be reached under the weight of the largest filled beverage container to be used with the beverage container holder.

The method used to mount the mesh to the tray, and the material the mesh is made of is variable depending on the material the tray is made of, the size and weight of the filled beverages to be used with the tray, and the cleaning and storage processes the tray will be subjected to. In all cases, the mesh is mounted to the tray in a permanent manner, and the material of the mesh is as durable and long lasting as the material of the tray itself.

The flexible mesh may formed of woven or non-woven material of suitable flexibility, and may have a regular, irregular, or radial pattern.

For the semi-mesh version, the material at the center of the mesh should be a material of similar characteristics as the tray itself, preferably of the same material.

The material at the center of the mesh should be large enough so that the bottom of the largest beverage container to be used rest within the confines of the disc of material

One advantage of the illustrated embodiment is that the likelihood of a beverage container tipping over during transport is greatly reduced.

Another advantage of the illustrated embodiment is that the likelihood of a beverage container sliding off during transport is virtually eliminated.

Another advantage of the illustrated embodiment is that reducing spills increases user satisfaction.

Another advantage of the illustrated embodiment is that reducing spills decreases the danger of slipping on the resulting spill, increasing safety overall safety and potentially reducing insurance rates.

Another advantage of the illustrated embodiment is that reducing spills reduces clean up costs.

Another advantage of the illustrated embodiment is that the integrated beverage container holder mesh remains flat when in storage, meaning no change to existing storage space requirements.

Another advantage of the illustrated embodiment is that the integrated mesh material is as durable as the tray material, allowing for existing cleaning methods and mechanisms to be used.

Another advantage of the semi-mesh design is that additional support is provide for the beverage being carried, and the amount of movement possible is further restricted, which further reduces the chance of spilling the beverage.

A food service tray with integrated beverage holder has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular.

What is claimed is:

1. A food tray for supporting food articles, the tray comprising:
a substantially flat support surface having a hole formed therein;
a lip around the hole; and
a stretchy mesh disposed across the hole.

2. The food tray of claim 1, wherein the stretchy mesh comprises plastic.

3. The food tray of claim 1, wherein the stretchy mesh comprises rubber.

4. The food tray of claim 1, wherein the stretchy mesh comprises a ring of plastic mesh with a disc of tray material in the center.

5. The food tray of claim 1, wherein the stretchy material comprises a ring of rubber mesh with a disc of tray material I the center.

6. The food tray of claim 1, wherein the stretchy mesh stretches at least about 1 to 2 inches below the surface of the substantially flat support surface.

7. The food tray of claim 1, wherein the stretchy mesh allows a beverage container disposed through the hole to sit below the substantially flat support surface.

8. A method manufacturing a food tray, the method comprising:
forming a substantially flat support surface with a substantially circular hole formed therethrough;
forming a lip surrounding the hole; and
fixing a flexible mesh across the hole.

9. The method of claim 8, further comprising fixing a disc of tray material at a center of the hole, said disc supported in position by the flexible mesh.

10. The method of claim 8, wherein the hole is sized to support a variety of beverage containers.
